(19) United States
(12) Patent Application Publication
(10) Pub. No.: US 2003/0081501 A1
(43) Pub. Date: May 1, 2003

(54) Reservoir evaluation apparatus and method

(75) Inventors: Geoffrey Nightingale, Katy, TX (US); Peter Maxwell, Missouri City, TX (US); Roy Devereux, Houston, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Input/Output, Inc., Stafford, TX (US)

(21) Appl. No.: 10/237,592

(22) Filed: Sep. 9, 2002

Related U.S. Application Data
(60) Provisional application No. 60/318,084, filed on Sep. 7, 2001.

(51) Int. Cl. G01V 1/40

(52) U.S. Cl. 367/57

(57) ABSTRACT

The present invention provides a vertical seismic imaging apparatus and method for evaluation a reservoir. The invention includes a plurality of sensors disposed in a well borehole either permanently cemented in place or retrievably disposed using a series of clamps to attach the sensors to the borehole wall. Each sensor uses one or more forced balanced controlled accelerometers to detect acoustic energy in the formation.

### CROSS-REFERENCE TO RELATED APPLICATION

This application is related to provisional U.S. patent application Ser. No. 60/318,084 filed on Sep. 7, 2001 the entire contents of which are hereby incorporated herein by reference.

### BACKGROUND OF THE INVENTION

1. Field of the Invention

This invention relates generally formation evaluation and more particularly to an apparatus and method for vertical seismic profiling of a reservoir.

2. Description of the Related Art

In the oil and gas industry, well boreholes are drilled into the earth to reach one or more hydrocarbon-bearing formations. These formations are called reservoirs. Once accessed by drilling operation, a reservoir becomes a producing well as the fluids and gas are extracted using suitable methods. This is known as the production phase of a well.

Reservoir monitoring and evaluation are important aspects of the production phase. One evaluation method is known as vertical seismic imaging or vertical seismic profiling (“VSP”). This evaluation method is typically practiced using a dedicated well borehole, i.e. a borehole other than a producing borehole. A sensor array having a plurality of sensors is lowered into the dedicated borehole and cemented in place. The sensors of a conventional system are geophones. In some cases a surface acoustic source is used to impart acoustic energy into the earth, thereby setting up an acoustic wave in the earth. In other cases, the sensor arrays are used to detect naturally occurring earth movements that create acoustic waves within the formation. Each sensor senses the acoustic wave, and signals from the sensors are transmitted for evaluation at the surface using known telemetry methods. The signal evaluation is used to determine various characteristics of the producing reservoir such as reservoir size and fluid migration.

There are several detrimental limitations associated with using the conventional system. Using geophones as a detector subjects the system to mechanical failure. The geophone is a spring-mass device that can fail in a harsh environment. The geophone-based sensor is relatively large and heavy thereby causing deployment problems. The conventional geophone-type system is limited in frequency response. And the conventional system has an upper limit for the number of sensors and cable length, i.e., the number of vertical levels, resulting from signal-noise ratio problems associated with the signal output characteristics of a geophone. Moreover, the typical system cannot easily correct for sensor tilt without the use of additional components such as magnetometers.

### SUMMARY OF THE INVENTION

The present invention addresses the above-identified problems found in the conventional seismic data acquisition system by providing a system having distributed control over the several units comprising the system. Additionally, the present invention provides an apparatus and method for packaging and transmitting data efficiently and with more reliability. Other advantages of the present invention include full vector wavefield measurement, improved vector fidelity as compared to conventional sensor arrays, and a wider dynamic range of frequencies for recording; especially high frequencies. The present invention provides a linear frequency response across a wide frequency spectrum as compared to a conventional system. The present invention includes fewer systems by moving most circuitry to the sensor package thereby improving overall reliability. The present invention also provides digital transmission by including delta-sigma 24-bit technology for converting analog signals to digital signals. The present inventions also provides for tilt compensation using a gravity acceleration component sensed by one or more of the orthogonal accelerometers. This allows for correcting signals regardless of the tilt of a particular sensor in the array.

Provided is a seismic data acquisition apparatus for determining a formation parameter of interest comprising a plurality of sensors disposed in a well borehole drilled in the formation for detecting acoustic energy. Each sensor includes at least one force balanced feedback controlled accelerometer for providing a sensor output indicative of the acoustic energy at the sensor location.

Another aspect of the invention provides a formation vertical seismic profiling system, comprising a plurality of sensors disposed in a well borehole drilled in the formation for detecting acoustic energy. Each sensor includes at least one force balanced feedback controlled accelerometer for providing a sensor output indicative of the acoustic energy at the sensor location. A controller is coupled determining the parameter of interest using the sensor output of one or more of the plurality of sensors.

Another aspect of the invention provides a method for sensing acoustic energy in a formation comprising disposing a plurality of sensors in a well borehole drilled into the formation each sensor including at least one force balanced feedback controlled accelerometer and sensing the acoustic energy with the plurality of sensors. The method also includes determining a parameter of interest using a controller coupled to the plurality of sensors, the parameter of interest being determined at least in part on the sensed acoustic energy.

### BRIEF DESCRIPTION OF THE DRAWINGS

The novel features of this invention, as well as the invention itself, will be best understood from the attached drawings, taken along with the following description, in which similar reference characters refer to similar parts, and in which:

FIG. 1 is an elevation view of a vertical seismic profiling (“VSP”) apparatus according to the present invention;

FIG. 2 shows an exemplary sonde according to the present invention; and

FIG. 3 shows one embodiment of a three-axis accelerometer for use in the sonde of FIG. 2.

### DETAILED DESCRIPTION OF THE INVENTION

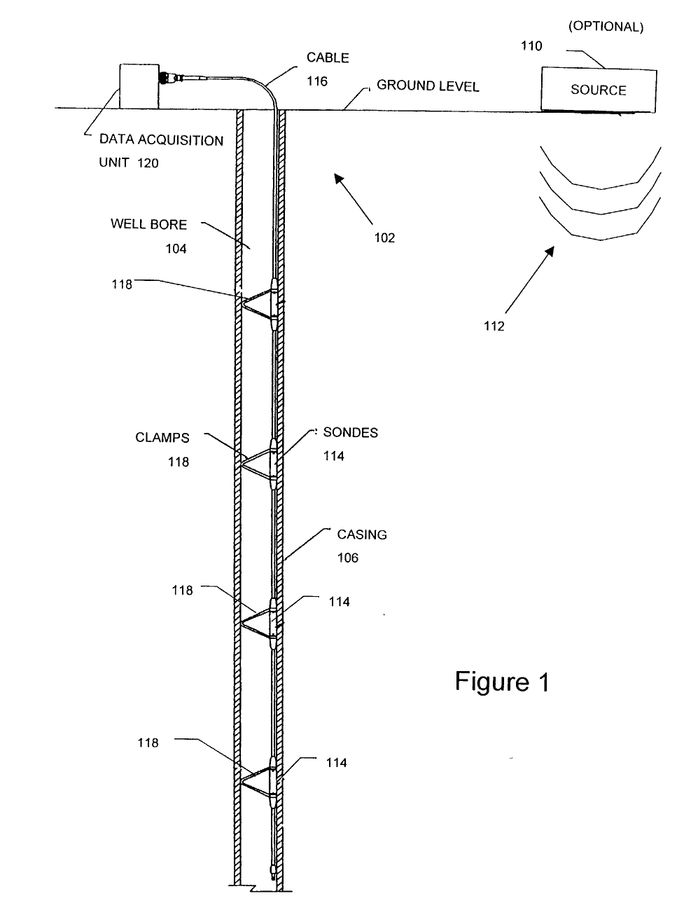

FIG. 1 is an elevation view of a vertical seismic profiling (“VSP”) apparatus 100 according to the present invention. The apparatus 100 comprises an energy source 110 and an evaluation unit 102.

The energy source 110 is preferably an acoustic source for imparting acoustic waves 112 into the earth.

The evaluation unit 102 includes a plurality of sondes 114 disposed along a cable 116 the combination of which provides a vertical array of sensors. The sensor array is disposed in a well borehole 104. The borehole may have a casing 106, but a cased well is not required for the present invention. The present invention may be used in a cemented dedicated borehole. The sonde may be cemented behind the casing i.e. between the casing and well borehole wall, or the sondes may be clamped in place using clamps 118 as shown. The clamps 118 may be used in either a cased or uncased borehole. In this retrievable embodiment, the clamps 118 may be retracted after completing a survey and the cable can be hoisted from the well borehole. Power for the clamping system and sondes is provided by a power supply (not separately shown) that may be located at a surface location. In one embodiment the power supply is in a data acquisition and control unit 120.

The sondes must be fixed in place and be in acoustic communication with the formation for effective VSP. Otherwise, acoustic waves 112 will not be detected with sufficient clarity to be useful. Although the sensors must be fixed during operation, it may be desirable to retrieve the sonde. Thus, a preferred embodiment includes a retrievable sensor array, which is clamped during operation.

The sensor array cable 116 is coupled to a data acquisition and control unit 120. The data acquisition and control unit receives signals from the sonde sensors via conductive wires in the cable 116. A processor (not separately shown is used to determine desired parameters of interest indicative of reservoir characteristics. Conductors other than wire are also contemplated by the present invention. For example, optic fibers may be utilized instead of or in conjunction with the conductive wires.

Each sensor along the sonde includes one or more accelerometers. The sensors are preferably three-component accelerometer-type sensors capable of sensing motion along three axes. In one embodiment, the three axes of sensitivity are orthogonal to one another. In one embodiment, the accelerometers are micro-electromechanical system (MEMS) accelerometers. In one embodiment the MEMS accelerometers are produced using micro-machining processes.

Signals sent to the surface from the sensors may analog or digital. In a preferred embodiment, the signals are digital. The output of each accelerometer may be transmitted to an analog to digital converter (ADC), or an accelerometer may be packaged with an ADC to provide a digital output.

In one embodiment of the present invention the energy source 110 is located within the borehole 104. In another embodiment, the source 110 is located in a separate borehole (not shown).

In a preferred embodiment, the present invention includes more than forty sondes. In one embodiment the invention includes 80 or more sondes.

In one embodiment the sondes are cemented into the well borehole for permanent installation.

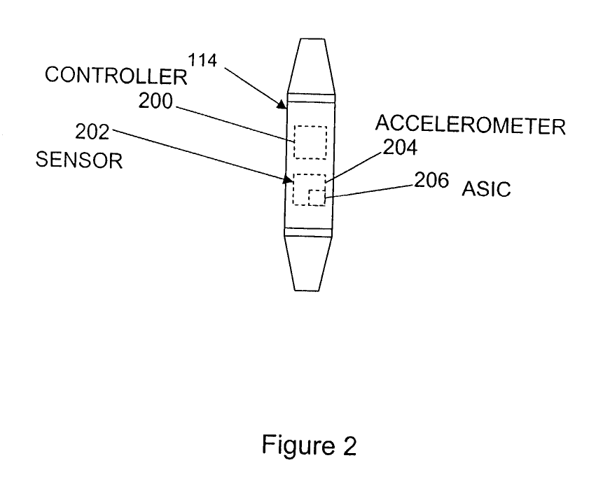

In another embodiment a retrievable sensor array Referring to FIG. 2, each sonde 114 preferably includes an optional controller 200 and a sensor 202. The sensor 202 preferably includes a micromachined MEMS accelerometer 204 combined with an application specific integrated circuit (ASIC) for providing forced balanced feedback control to the accelerometer 204. In a preferred embodiment, the sensor 202 is a three component accelerometer for providing three orthogonal axes of sensitivity. These integrated sensors are readily available from Input Output, Inc. located at 12300 Parc Crest Drive, Stafford, Tex. 77477 USA.

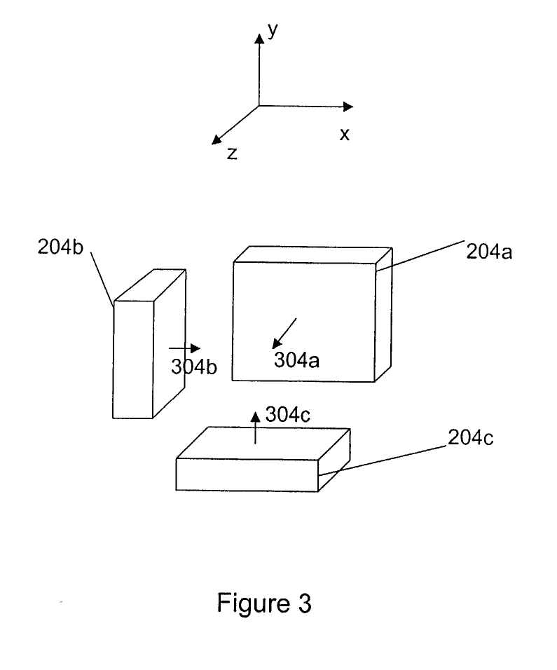

Referring to FIG. 3, the sensor 202 preferably includes one or more accelerometers 204. The sensor 202 is preferably coupled to the controller 200 and includes a first accelerometer 204a, a second accelerometer 204b, and a third accelerometer 204c. In a preferred embodiment, each accelerometer 204 further includes one or more axes of sensitivity 304. The first accelerometer 204a preferably includes a first axis of sensitivity 304a. The first axis of sensitivity 304a is preferably approximately parallel to the z-axis. The second accelerometer 204b preferably includes a second axis of sensitivity 304b. The second axis of sensitivity 304b is preferably approximately parallel to the x-axis. The third accelerometer 204c preferably includes a third axis of sensitivity 304c. The third axis of sensitivity 304c is preferably approximately parallel to the y-axis. The axes of sensitivity 304 are preferably approximately orthogonal to each other.

Each accelerometer 204 preferably includes a corresponding application specific integrated circuit (ASIC) 206. Each accelerometer 204 is preferably coupled to the corresponding ASIC 206. The ASIC 206 preferably includes feedback circuitry adapted to provide force balanced feedback to the corresponding accelerometer 204. The ASIC 206 also preferably includes memory for storage of individual parameters for each corresponding accelerometer 204. The ASIC 206 also preferably includes digitization circuitry to provide for a digital output from each corresponding accelerometer 204. The ASIC 206 may be, for example, an analog integrated circuit using analog components to generate feedback and providing analog accelerometer output or a mixed signal integrated circuit using a combination of analog and digital components to generate feedback and providing digital accelerometer output.

In one embodiment, the three component sensor is used to provide a gravity vector component output. The output is transmitted and processed along with the sensed acoustic energy. The gravity component is used for correcting error associated with tilt of any particular sensor in the array. Thus the sensors 202 are substantially tilt insensitive.

The foregoing description is directed to particular embodiments of the present invention for the purpose of illustration and explanation. It will be apparent, however, to one skilled in the art that many modifications and changes to the embodiment set forth above are possible without departing from the scope and the spirit of the invention. It is intended that the following claims be interpreted to embrace all such modifications and changes.

What is claimed is:

1. A seismic data acquisition apparatus for sensing acoustic energy in a formation, comprising:
a) a plurality of sensors disposed in a well borehole drilled in the formation for detecting the acoustic energy, each sensor including at least one forced balanced feedback controlled accelerometer for providing a sensor output indicative of the acoustic energy at the sensor location.

2. The apparatus of claim 1, wherein the accelerometers are MEMS accelerometers.

3. The apparatus of claim 1, wherein the at least one accelerometer comprises three accelerometers for providing the sensor with having three axes of sensitivity.

4. The apparatus of claim 3, wherein the three axes of sensitivity are orthogonal.

5. The apparatus of claim 1, wherein the plurality of sensors is retrievably disposed within the well borehole.

6. The apparatus of claim 1, further comprising a clamp coupled to at least one of the plurality of sensors for selectively fixing the sensor in acoustic communication with the borehole wall.

7. The apparatus of claim 1, wherein the borehole wall is cased, the apparatus further comprising a clamp coupled to at least one of the plurality of sensors for selectively fixing the sensor in acoustic communication with the borehole wall through the casing.

8. The apparatus of claim 1, wherein the borehole wall is cased and wherein the plurality of sensors is permanently cemented in the casing fixing the sensors in acoustic communication with the borehole wall through the casing.

9. The apparatus of claim 1, wherein the plurality of sensors is arranged in a vertical array of at least forty levels.

10. The apparatus of claim 1, wherein the plurality of sensors is arranged in a vertical array of at least eighty or more levels.

11. The apparatus of claim 1, wherein the sensed acoustic energy originates at least in part from naturally occurring movements within the earth.

12. The apparatus of claim 1, wherein the sensed acoustic energy originates at least in part from an acoustic source device.

13. The apparatus of claim 1, wherein the forced balanced feedback control is provided at least in part by and ASIC circuit coupled to the accelerometer.

14. The apparatus of claim 13, wherein the ASIC circuit is an analog feedback circuit.

15. The apparatus of claim 13, wherein the ASIC circuit is a digital feedback circuit.

16. The apparatus of claim 1, wherein the sensor output includes an analog signal.

17. The apparatus of claim 1, wherein the sensor output includes a digital signal.

18. The apparatus of claim 1, wherein each of the plurality of sensors is housed within a sonde, the sonde further housing a controller for controlling the sensor.

19. A formation vertical seismic profiling system, comprising:
a) a plurality of sensors disposed in a well borehole drilled in the formation for detecting acoustic energy, each sensor including at least one forced balanced feedback controlled accelerometer for providing a sensor output indicative of the acoustic energy at the sensor location; and
b) a first controller coupled to the plurality of sensors for determining the parameter of interest using the sensor output of one or more of the plurality of sensors.

20. The system of claim 19, wherein the accelerometers are MEMS accelerometers.

21. The system of claim 19, wherein the at least one accelerometer comprises three accelerometers for providing the sensor with having three axes of sensitivity.

22. The system of claim 21, wherein the three axes of sensitivity are orthogonal.

23. The system of claim 19, wherein the plurality of sensors is retrievably disposed within the well borehole.

24. The system of claim 19, further comprising a clamp coupled to at least one of the plurality of sensors for selectively fixing the sensor in acoustic communication with the borehole wall.

25. The system of claim 19, wherein the borehole wall is cased, the system further comprising a clamp coupled to at least one of the plurality of sensors for selectively fixing the sensor in acoustic communication with the borehole wall through the casing.

26. The system of claim 19, wherein the borehole wall is cased and wherein the plurality of sensors is permanently cemented in the casing fixing the sensors in acoustic communication with the borehole wall through the casing.

27. The system of claim 19, wherein the plurality of sensors is arranged in a vertical array of at least forty levels.

28. The system of claim 19, wherein the plurality of sensors is arranged in a vertical array of at least eighty or more levels.

29. The system of claim 19, wherein the sensed acoustic energy originates at least in part from naturally occurring movements within the earth.

30. The system of claim 19, wherein the sensed acoustic energy originates at least in part from an acoustic source device.

31. The system of claim 19, wherein the forced balanced feedback control is provided at least in part by and ASIC circuit coupled to the accelerometer.

32. The system of claim 31, wherein the ASIC circuit is an analog feedback circuit.

33. The system of claim 31, wherein the ASIC circuit is a digital feedback circuit.

34. The system of claim 19, wherein the sensor output includes an analog signal.

35. The system of claim 19, wherein the sensor output includes a digital signal.

36. The system of claim 19, wherein each of the plurality of sensors is housed within a sonde, the sonde further housing a second controller for controlling the sensor.

37. The system of claim 19, wherein each of the plurality of sensors provides a gravity component in the sensor output, the first controller using the gravity component to correct for sensor tilt.

38. A method of sensing acoustic energy in a formation, comprising:
a) disposing a plurality of sensors in a well borehole drilled into the formation each sensor including at least one force balanced feedback controlled accelerometer; and
b) sensing the acoustic energy within the formation using the plurality of sensors.; and
d) determining a parameter of interest using a controller coupled to the plurality of sensors, the parameter of interest being determined at least in part on the sensed acoustic energy.

39. The method of claim 38 further comprising determining a parameter of interest using a controller coupled to the plurality of sensors, the parameter of interest being determined at least in part on the sensed acoustic energy.

40. The method of claim 38, wherein disposing the sensors further comprises retrievably disposing the sensors in the borehole.

41. The method of claim 38, wherein the accelerometers are MEMS accelerometers.

42. The method of claim 38, wherein the at least one accelerometer comprises three accelerometers, the method further comprising sensing acoustic energy along three axes of sensitivity.

43. The method of claim 42, wherein the three axes of sensitivity are orthogonal.

44. The method of claim 38 further comprising selectively fixing at least one of the plurality of sensors in acoustic communication with the borehole through the casing wall using a clamp coupled to the at least one of the plurality of sensors.

45. The method of claim 38 further comprising permanently fixing at least one of the plurality of sensors in acoustic communication with the borehole wall through the casing by cementing the at least one of the plurality of sensors in the casing.

46. The method of claim 38, wherein disposing the plurality of sensors further comprises arranging the sensors in a vertical array of at least forty levels.

47. The method of claim 38, wherein disposing the plurality of sensors further comprises arranging the sensors in a vertical array of at least eighty or more levels.

48. The method of claim 38, wherein the sensed acoustic energy originates at least in part from naturally occurring movements within the earth.

49. The method of claim 38, wherein the sensed acoustic energy originates at least in part from an acoustic source device.

50. The method of claim 38, wherein the forced balanced feedback control is provided at least in part by and ASIC circuit coupled to the accelerometer.

51. The method of claim 50, wherein the ASIC circuit is an analog feedback circuit.

52. The method of claim 50, wherein the ASIC circuit is a digital feedback circuit.

53. The method of claim 38, wherein the sensor output includes an analog signal.

54. The method of claim 38, wherein the sensor output includes a digital signal.

55. The method of claim 38, wherein each of the plurality of sensors is housed within a sonde, the sonde further housing a second controller for controlling the sensor.

56. The method of claim 38, wherein each of the plurality of sensors provides a gravity component, the method further comprising using the gravity component to correct for sensor tilt.
